(19) United States
(12) Patent Application Publication
(10) Pub. No.: US 2014/0345946 A1
(43) Pub. Date: Nov. 27, 2014

(54) Analysis of Geological Objects

(71) Applicant: WesternGeco L.L.C., Houston, TX (US)

(72) Inventors: Jan Øystein Haavig Bakke, Stavanger (NO); Oddgeir Gramstad, Algard (NO)

(73) Assignee: WestemGeco L.L.C., Houston, TX (US)

(21) Appl. No.: 14/370,056

(22) PCT Filed: Jan. 18, 2013
(86) PCT No.: PCT/IB2013/050473

§ 371 Date: Jun. 30, 2014

(30) Foreign Application Priority Data
Jan. 18, 2012 (GB) 1200773.8

(51) Int. Cl. G01V 1/34; E21B 47/12; G01V 1/30

(52) U.S. Cl. CPC G01V 1/345; G01V 1/30; E21B 47/12
USPC 175/50; 702/16; 382/109

(57) ABSTRACT

A computer-implemented method of determining a search expression describing a feature of interest in a set of data points distributed throughout a geological object is provided. Each data point contains a value for a geological attribute at that point. The search expression has a plurality of entries. The method including the steps of: (i) displaying the geological object using display codings corresponding to value subranges for the geological attribute such that all data points which have values for the geological attribute falling within a given value subrange are displayed with the same coding; (ii) selecting a plurality of data points of the feature of interest; and (iii) allocating value characters to entries of the search expression, the value characters corresponding to the value subranges for the geological attribute of the selected data points.

### BACKGROUND

This disclosure relates in general to the analysis of geological objects and, more specifically, but not by way of limitation, to the analysis of seismic attributes of geological objects.

The characterisation of subsurface strata is important for identifying, accessing and managing reservoirs. The depths and orientations of such strata can be determined, for example, by seismic surveying. This is generally performed by imparting energy to the earth at one or more source locations, for example, by way of controlled explosion, mechanical input etc. Return energy is then measured at surface receiver locations at varying distances and azimuths from the source location. The travel time of energy from source to receiver, via reflections and refractions from interfaces of subsurface strata, indicates the depth and orientation of the strata.

U.S. Pat. No. 7,248,539 discloses a method for automated extraction of surface primitives from seismic data. For example, one embodiment of the method of U.S. Pat. No. 7,248,539 involves defining, typically with sub-sample precision, positions of seismic horizons through an extrema representation of a 3D seismic input volume; deriving coefficients that represent the shape of the seismic waveform in the vicinity of the extrema positions; sorting the extrema positions into groups that have similar waveform shapes by applying classification techniques with the coefficients as input attributes using unsupervised or supervised classification based on an underlying statistical class model; and extracting surface primitives as surface segments that are both spatially continuous along the extrema of the seismic volume and continuous in class index in the classification volume.

The characterisation of faults and fractures in reservoir formations can also be important. For example, fractures intersecting drilled wells may assist the flow of hydrocarbons from the reservoir and so increase production. Conversely, fractures may allow water to flow into wells and so decrease production.

WO 2008/086352 describes a methodology for mapping fracture networks from seismic data using fracture enhancement attributes and fracture extraction methods. For example, borehole data can be used to determine modes of fracture, and in particular whether fracture clusters or networks would be detectable in surface seismic data. It can also provide information on fracture network inclination (i.e. average inclination of the fractures in a network relative to the horizontal) and strike azimuth (i.e. average direction of intersection of the fractures in a network relative to the horizontal).

Discontinuity extraction software (DES), for example as described in U.S. Pat. No. 7,203,342, may then be utilised to extract 3D volumes of fracture networks from surface seismic data. Extracted fracture networks may be parameterised in terms of the strength of their seismic response, and on their length, height and width.

The approach of U.S. Pat. No. 7,203,342 may also be used to characterise and extract other geological features, such as faults, from seismic data.

However, a problem arises of identifying relevant information in geological volumes, which volumes may contain large amounts of seismic and other geological information. Thus WO2011/077300 proposes a method of processing data points distributed throughout a geological volume, each data point being associated with respective geological attributes, such as seismic attributes, geometric attributes or numerical modelling derived attributes. The method includes the steps of: coding the geological attributes of each data point as a respective character string; compiling a query character string defining sought geological attributes of an arrangement (e.g. a line) of one or more data points; searching the coded geological attributes for arrangements of data points having geological attributes matching the query character string; and identifying matched data points. The identified data points can then be graphically displayed. By coding the geological attributes as character strings, large amounts of information can be presented in a format that facilitates fast and efficient searching by the query character string. For example, the graphical display may show surface horizons associated with the identified data points.

### SUMMARY

Accordingly, a first aspect of an embodiment of the present invention provides a computer-implemented method of identifying a feature of interest in a set of data points distributed throughout a geological object, each data point containing a value for a geological attribute at that point, the method including the steps of:
providing a translator which defines a plurality of value subranges for the geological attribute;
displaying the geological object using display codings corresponding to the value subranges such that all data points which have values for the geological attribute falling within a given value subrange are displayed with the same coding;
repeatedly adjusting one or more end values of the value subranges, and redisplaying the geological object using the respective display codings for the adjusted value subranges, until the feature of interest is identifiable in the redisplayed geological object. The method can include the further step of identifying the feature of interest in the redisplayed geological object. The method can further include the step of displaying the value subranges of the translator as translator GUI elements (e.g. including the display codings), and wherein the adjustment of the one or more end values of the value subranges is performed by adjusting the translator GUI elements.

By displaying and redisplaying the geological object using the (adjusted) value subranges, a user can be facilitated to arrive at a view of the object, which allows the user to easily identify features of interest in the data points.

The method of the first aspect can further include the step of determining a search expression describing the feature of interest, the search expression having a plurality of entries, wherein the determining step includes performing the steps of:
selecting a plurality of data points of the feature of interest; and
allocating value characters to entries of the search expression, the value characters corresponding to the value subranges for the geological attribute of the selected data points.

By allocating the value characters corresponding to the value subranges for the geological attribute of the selected data points, a user can be enabled to determine a suitable search expression even if he does not have particular expertise in and experience of such expressions.

Indeed, a second aspect of an embodiment of the present invention provides a computer-implemented method of determining a search expression describing a feature of interest in a set of data points distributed throughout a geological object, each data point containing a value for a geological attribute at that point, and the search expression having a plurality of entries, the method including the steps of:
displaying the geological object using display codings corresponding to value subranges for the geological attribute such that all data points which have values for the geological attribute falling within a given value subrange are displayed with the same coding;
selecting a plurality of data points of the feature of interest; and
allocating value characters to entries of the search expression, the value characters corresponding to the value subranges for the geological attribute of the selected data points.

A third aspect of an embodiment of the present invention provides a method of processing seismic data including the steps of:
performing seismic tests to obtain seismic data for a geological volume;
performing the method of the first or second aspect, the set of data points being based on the seismic data or a subset of the seismic data.

A fourth aspect of an embodiment of the present invention provides a method of controlling a well drilling operation including the steps of:
performing the method of the second aspect (optionally including a preliminary step of performing seismic tests to obtain seismic data for a geological volume, the set of data points of the second aspect being based on the seismic data or a subset of the seismic data) to identify features of interest corresponding to matched arrangements of data points;
determining a well trajectory which extends through the geological object taking account of the identified features of interest; and
drilling a well having the specified trajectory.

Further aspects of embodiments of the invention provide (i) a computer system, (ii) a computer program product carrying a program, and (iii) a computer program, each for performing the method of the first or second aspect.

For example, a computer system for identifying a feature of interest in a set of data points distributed throughout a geological object, each data point containing a value for a geological attribute at that point, can include:
a computer-readable medium or media which stores the data points; and
a processor(s) configured to:
   (a) provide a translator which defines a plurality of value subranges for the geological attribute,
   (b) control a display unit to display the geological object using display codings corresponding to the value subranges such that all data points which have values for the geological attribute falling within a given value subrange are displayed with the same coding, and
   (c) adjust one or more end values of the value subranges in response to user input, and control the display unit to redisplay the geological object using the respective display codings for the adjusted value subranges. The computer system may also include the display unit controlled by the processor. The processor(s) may also be configured to control the display unit to display the value subranges of the translator as translator GUI elements. The user input to adjust one or more end values of the value subranges can then be performed by the user adjusting the translator GUI elements.

Also for example, a computer system for determining a search expression describing a feature of interest in a set of data points distributed throughout a geological object, each data point containing a value for a geological attribute at that point, and the search expression having a plurality of entries, can include:
a computer-readable medium or media which stores the data points; and
a processor(s) configured to:
   (a) control a display unit to display the geological object using display codings corresponding to value subranges for the geological attribute such that all data points which have values for the geological attribute falling within a given value subrange are displayed with the same coding, and
   (b) in response to user input selecting a plurality of data points of the feature of interest, allocate value characters to entries of the search expression, the value characters corresponding to the value subranges for the geological attribute of the selected data points. The computer system may also include the display unit controlled by the processor. The user input to selecting a plurality of data points of the feature of interest can then be performed by the user making the selection (e.g. by pointing and clicking) on the displayed geological object.

Further optional features of the invention will now be set out. These are applicable singly or in any combination with any aspect of the invention.

The display codings can conveniently be colours and/or grey scales.

The step of selecting a plurality of data points can be performed by pointing at data points in the feature of interest.

The geological object can be 1D, 2D or 3D. Examples of data sets of 1D objects are well logs or seismic traces. Examples of data sets of 2D objects are 2D seismic lines, any attribute derived from 2D seismic lines and in general any image. Examples of data sets of 3D objects are 3D seismic cubes and any attribute derived from 3D seismic cubes.

When the geological object is a 1D object, the allocating step can further include allocating extent characters to the entries of the search expression, each extent character being associated with a respective entry and specifying the vertical extent of the continuous line of data points which share the value subrange of that entry and which include the selected data point of that entry. The allocating step may then also further include allocating additional value and extent characters to further entries of the search expression, each further entry corresponding to a respective gap between adjacent continuous lines, additional value characters of each further entry corresponding to the value subranges for the geological attribute of the data points within the respective gap, and an additional extent character of each further entry specifying the vertical extent of the respective gap.

When the geological object is a 2D object, the allocating step can further include allocating pairs of extent characters to the entries of the search expression, each pair of extent characters being associated with a respective entry and specifying the minimum and maximum vertical extents of the contiguous area of data points which share the value subrange of that entry and which include the selected data point of that entry. The allocating step may then also further include allocating additional value and extent characters to further entries of the search expression, each further entry corresponding to a respective vertical gap between adjacent contiguous areas, additional value characters of each further entry corresponding to the value subranges for the geological attribute of the data points within the respective gap, and a pair of additional extent characters of each further entry specifying the minimum and maximum vertical extents of the respective gap.

When the geological object is a 3D object, the allocating step can further include allocating pairs of extent characters to the entries of the search expression, each pair of extent characters being associated with a respective entry and specifying the minimum and maximum vertical extents of the contiguous volume of data points which share the value subrange of that entry and which include the selected data point of that entry. The allocating step may then also further include allocating additional value and extent characters to further entries of the search expression, each further entry corresponding to a respective vertical gap between adjacent contiguous volumes, additional value characters of each further entry corresponding to the value subranges for the geological attribute of the data points within the respective gap, and a pair of additional extent characters of each further entry specifying the minimum and maximum vertical extents of the respective gap.

The method may further include the step of displaying the value characters of the search expression as search expression GUI elements using the display codings.

The method may further include modifying one or more value characters of the search expression. For example, when the value characters are displayed as search expression GUI elements using the display codings, the modifying may be performed by adjusting the search expression GUI elements. The method may further include modifying one or more extent characters of the search expression. The method may further include adding entries to and/or removing entries from the search expression.

The method may further include the steps of:
searching the set of data points for arrangements of data points having geological attributes matching the search expression; and
identifying matched arrangements of data points. The method may then typically also include redisplaying the geological object (for example, using the display codings, different display codings and/or the original geological attribute) and indicating the positions of the matched arrangements of data points.

In general, each data point may also contain a value for one or more further geological attributes at that point. More particularly, if each data point also contains a value for a second geological attribute at that point, and matched arrangements of data points have been identified (and optionally the geological object has been redisplayed), the method may further include the steps of:
displaying the geological object using second display codings (such as colours and/or grey scales) corresponding to second value subranges for the second geological attribute such that all data points which have values for the second geological attribute falling within a given second value subrange are displayed with the same second coding, and indicating the positions of the matched arrangements of data points; and
determining a second search expression having entries corresponding to the entries of the first search expression but having value characters which correspond to the second value subranges for the second geological attribute of the matched arrangements of data points. The method may then further include the step of displaying the value characters of the second search expression as second search expression GUI elements using the second display codings.

The method may then further include the steps of:
modifying one or more value characters of the second search expression (for example, by adjusting the second search expression GUI elements); and
redisplaying the geological object (for example, using the first display codings, the second display codings, different display codings, and/or an original geological attribute) and indicating the positions of the previously matched arrangements of data points which still match the modified second search expression.

Each data point can also contain a value for one or more additional (typically nondisplayed) geological attributes at that point, and the or each additional geological attribute can have corresponding value subranges. The method can then further include the step of:
determining one or more additional search expressions, the or each additional search expression having entries corresponding to the entries of the first search expression but having value characters which correspond to the value subranges for a respective one of the additional geological attributes according to the matched arrangements of data points.

Further optional features of the invention are set out below.

### BRIEF DESCRIPTION OF THE DRAWINGS

Embodiments of the invention will now be described by way of example with reference to the accompanying drawings in which:

FIG. 1 is a flow chart showing stages in a first part of a methodology which enables the creation and utilisation of search expressions for analysing geological objects, in accordance with an embodiment of the present invention;

FIG. 2 is a flow chart showing stages in further parts of the methodology, in accordance with an embodiment of the present invention;

FIG. 3 shows a seismic amplitude cross-section;

FIG. 4 shows the cross-section of FIG. 3 after translation, in accordance with an embodiment of the present invention;

FIG. 5 shows a GUI which allows a user to set up and manipulate a translator and a search expression to be used in relation to a display of a geological attribute, in accordance with an embodiment of the present invention;

FIG. 6 shows a displayed seismic amplitude cross-section translated into three value subranges (coloured red, green and blue), in accordance with an embodiment of the present invention;

FIG. 7 shows a schematic drawing of a rectangle of interest from FIG. 6, two reflectors extending across the rectangle;

FIG. 8 shows at top the translated seismic amplitude cross-section of FIG. 6, and at bottom a corresponding GUI, circles in the cross-section indicate positions which match a search expression defined in the GUI, in accordance with an embodiment of the present invention;

FIG. 9 shows the translated seismic amplitude cross-section and GUI of FIG. 6, but with the search expression defined in the GUI increased by three further entries, and a consequent decrease in matched points in the cross-section, in accordance with an embodiment of the present invention;

FIG. 10 shows the translated seismic amplitude cross-section and GUI of FIG. 9, but with an adjustment to a translator defined in the GUI, and a further consequent decrease in matched points in the cross-section, in accordance with an embodiment of the present invention;

FIG. 11 shows matched data points resulting from applying the translator and search expression of FIG. 10 across the 3D seismic volume from which the cross-section of FIGS. 6 and 8 to 10 was taken, in accordance with an embodiment of the present invention;

FIG. 12 shows (a) a seismic cross-section, and (b) the same seismic cross-section overlaid with AntTracks based on a chaos attribute;

FIG. 13 shows at bottom the translated seismic cross-section of FIG. 12(a), and at top a GUI representation of a six entry search expression that has produced matched points in the cross-section, in accordance with an embodiment of the present invention;

FIG. 14 shows at bottom the translated seismic cross-section of FIG. 12(b), and at top GUI representations of the search expression of FIG. 13 and a second search expression that has produced matched points in the cross-section, in accordance with an embodiment of the present invention;

FIG. 15 is identical to FIG. 14 except that the second search expression has been adjusted to remove matched points at fault positions, in accordance with an embodiment of the present invention; and

FIG. 16 shows the matched points of FIG. 15 overlayed on the seismic cross-section of FIG. 12(a), in accordance with an embodiment of the present invention.

### DETAILED DESCRIPTION

Specific details are given in the following description to provide a thorough understanding of the embodiments. However, it will be understood by one of ordinary skill in the art that embodiments maybe practiced without these specific details. For example, well-known circuits, processes, algorithms, structures, and techniques may be shown without unnecessary detail in order to avoid obscuring the embodiments.

Also, it is noted that embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

As disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

WO2011/077300 describes a process in which input data is coded, or translated, from continuous values to discrete characters. The translated data in the form of characters can then be searched using e.g. regular expressions. The use of regular expressions allows for very flexible searches, not just in the variations of the values of the data, but also in the length of sought after features, and even with respect to the existence of a smaller feature inside a larger feature.

However, the method of WO2011/077300 can require a high level of knowledge to create a search expression that matches the characteristic pattern of a feature. Also the translation often has to be tuned, typically in combination with adjustments to the search expression, to obtain a useful result. It would be desirable to facilitate increase uptake of the process by users, such as geologists and geophysicists, who may not have particular expertise in and experience of regular expressions.

Accordingly, a methodology is provided which enables the creation and utilisation of search expressions for analysing geological objects, such as seismic cubes, using a GUI. A user can employ the technique to be able to create searches without knowledge of the underlying search technology. The methodology has several parts:
A translator allows the user to translate data points in the object from continuous values of a geological attribute to partitioned value subranges of the attribute, and then displays the object having the translated data points. A GUI can allow the user to update the translator such that changes in the translator are reflected in changes to the displayed object. In this way, features of interest in the redisplayed object can become identifiable. Typical changes are to the overall scale of the translator and/or to individual endpoints of the value subranges.
The user then selects parts of the translated data, e.g. with a GUI pointing device, and the selected data is used to form a search expression.
The GUI displays the search expression and allows the user to edit the expression manually. The expression is used to search for arrangements of data points matching the search expression.
The matched arrangements of data points are displayed, together with the data points showing the original continuously valued geological attribute or the translated data points. The search results can be updated automatically when any of the inputs are varied, e.g. when the translator or the search expression is changed in the GUI. The translator and the search expression can be stored for future use.

The geological object can be 1D, 2D or 3D and accordingly has corresponding 1D, 2D or 3D datasets. Examples of 1D datasets are well logs or seismic traces. Examples of 2D datasets are 2D seismic lines, any attribute derived from 2D seismic lines, and generally any image. Examples of 3D datasets are 3D seismic cubes and any attribute derived from 3D seismic cubes.

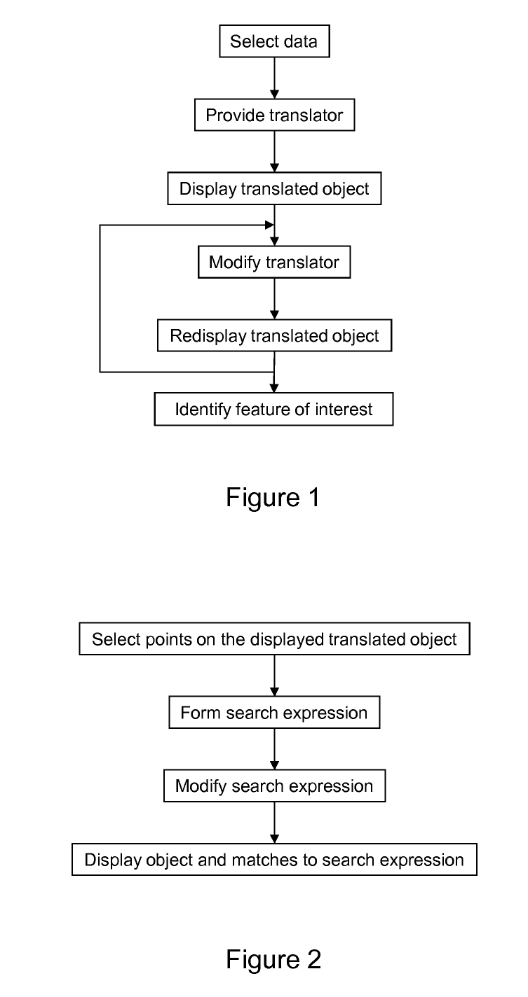

FIG. 1 is a flow chart showing stages in the first part of the methodology, and FIG. 2 is a flow chart showing stages in the second, third and fourth parts of the methodology.

By (i) automatically creating search expressions based on user input on a display of translated input data, (ii) graphical display of search expressions, and (iii) real time updating of translated input data and search results upon changes in one or more of input data, translator and search expression, users can be empowered to create, modify and use search expressions without requiring expert knowledge of them.

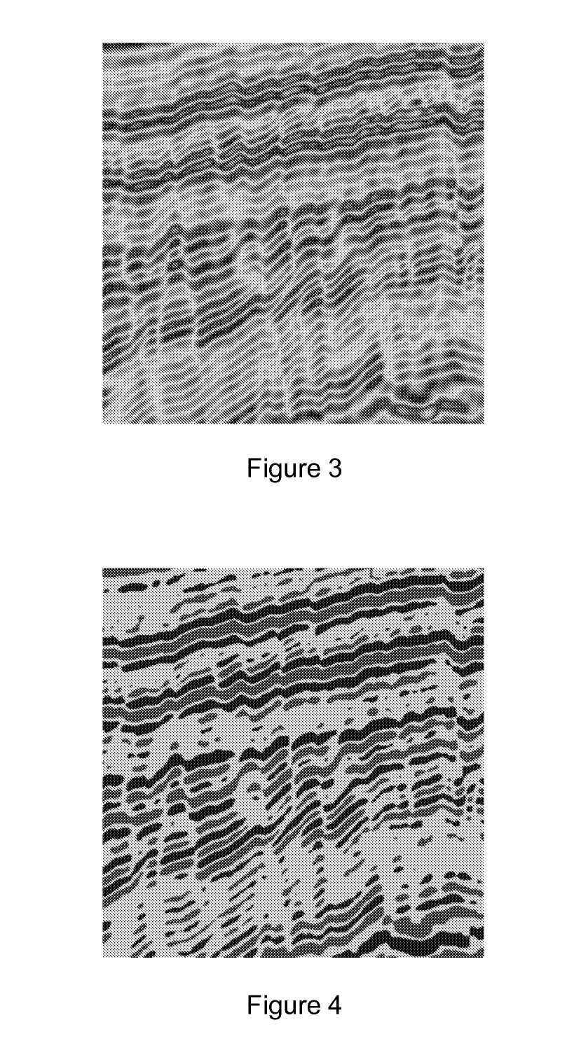

FIG. 3 shows a seismic amplitude cross-section (i.e. an example of a 2D geological object). The data points which make up the cross-section contain respective amplitude values. These values can each be allocated to one of several different value subranges. Thus, for example, if the amplitude values can be anywhere in the range of from −0.5 to +0.5, possible value subranges might be −0.5 to −0.2, -0.2-0.2, and 0.2 to 0.5. FIG. 4 shows the cross-section of FIG. 3 redisplayed with three different colours providing suitable display codings to represent the three value subranges.

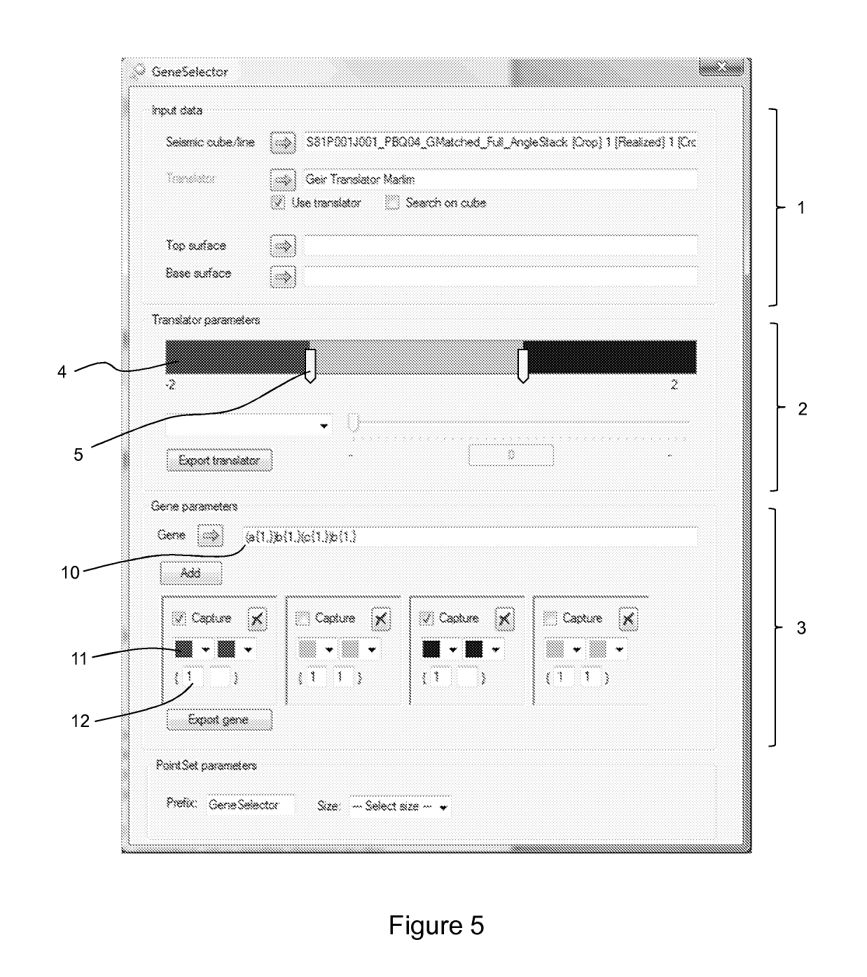

FIG. 5 shows a GUI which allows a user to set up and manipulate a translator which defines a plurality of value subranges for a geological attribute (such as seismic amplitude). The GUI has a top pane 1 with which the user specifies the input data. In a middle pane 2, a colour bar 4 displays the colours of the value subranges, with the length of each individually coloured portion of the bar representing the extent of the respective range, and the positions of the ends of each coloured portion representing the end values of the respective range. In the example shown, the translator covers a total extent of from −2 to +2. The end values and extents can be manipulated using elements such as sliders 5, or by entering end values into appropriate text entry boxes.

When the value subranges are adjusted using the middle pane 2 of the GUI, the translated cross-section is automatically redisplayed, giving the user immediate feedback on the effect of the adjustments.

By making adjusting to the translator, the user can be assisted in identifying features of interest in the redisplayed geological object. In particular, the user can then go on to define a search expression based on a feature of interest.

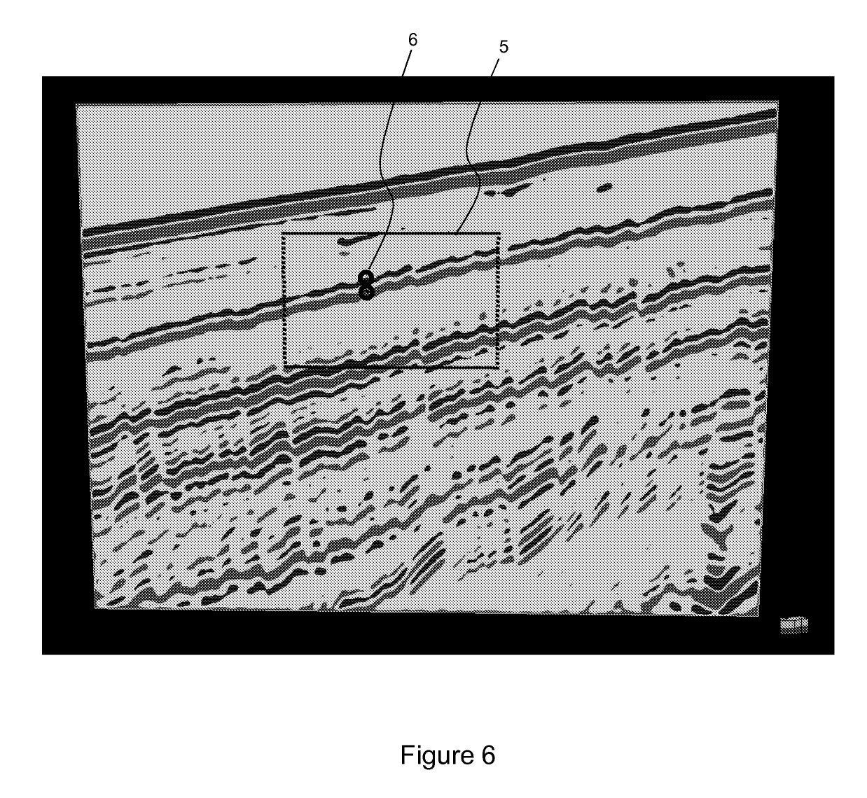

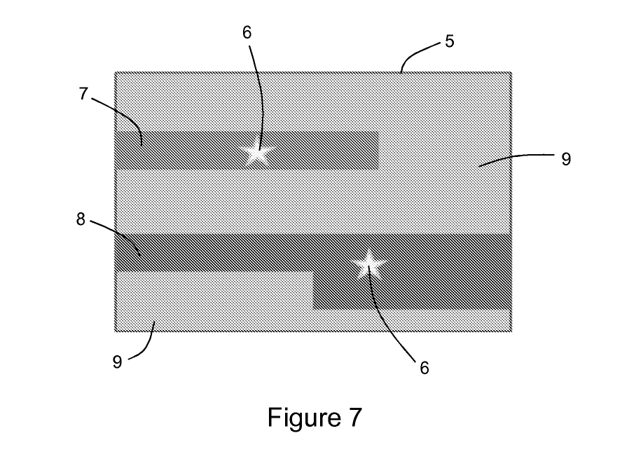

FIG. 6 shows a displayed seismic amplitude cross-section again translated into three value subranges (coloured red, green and blue). A rectangle 5 of interest is marked on the cross-section using a mouse, and two points 6 (indicated by circles) on a feature of interest within the rectangle are selected by pointing-and-clicking. The features of interest are a blue reflector followed by a red reflector. In addition there is a wide low amplitude region (green colour) above and below the two features.

From the selected features and the selected area of interest, a search expression is generated. FIG. 7 shows a schematic drawing of the rectangle 5 of FIG. 6. Contained in the rectangle are part of a seismic line formed from the blue reflector 7 and the red reflector 8, with surrounding green regions 9 of low amplitude reflection. The selected points 6 are indicated with stars. The blue reflector 7 has a high positive seismic amplitude, is one data point thick, and disappears to the right on the seismic line. The red reflector 8, has a high negative seismic amplitude, is one data point thick at the left, and grows to two data points thick at the right.

The following algorithm can be used to determine a search expression:
1) Sort the selected points 6 from top to bottom
2) For each selected point, find the minimum and maximum vertical extents and the horizontal extent within the rectangle 5 of the connected cluster (i.e. the contiguous area of data points) with the same colour as the selected point
3) For each selected point in sorted order, and starting with the topmost selected point, create a search expression entry which includes the colour (typically in the form of a character representing the corresponding value subrange) of the selected point, and the minimum and maximum vertical extents of the corresponding connected cluster
4) If this is not the last selected point, create a further search expression entry based on the gap between the connected cluster of this selected point and the connected cluster of the next selected point. The further entry includes the colours (again typically in the form of characters representing the corresponding value subranges) of all the colours encountered in the gap between the two clusters, and the minimum and maximum vertical extents of the gap.
5) Repeat 3) and 4) with the next selected point

For example, in relation to FIG. 7 the search expression is ([a]{1,1})[b]{2,2}([c]{1,2}), where [a] represents the blue value subrange, [b] represents the green value subrange, and [c] represents the red value subrange, and the pair of numbers in the adjacent curly brackets are the corresponding minimum and maximum vertical extents. Thus, ([a]{1,1}) detects the blue reflector 7 of uniform thickness, [b]{2,2} describes the green gap between the two reflector 7, 8, ([c]{1,2}) detects the red reflector 8 of varying thickness.

The algorithm can be readily extended to 3D data by detecting the clusters in three dimensions.

Once determined, the search expression can be displayed graphically. In the GUI of FIG. 5, a four entry search expression is shown in the bottom pane 3. The search expression is displayed as a character string in text window 10. However, in addition, the value subrange(s) of each entry are displayed using the corresponding colours in drop down boxes 11, and the minimum and maximum vertical extents of each entry are also displayed in adjacent text entry boxes 12. These allow the user to easily modify the search expression.

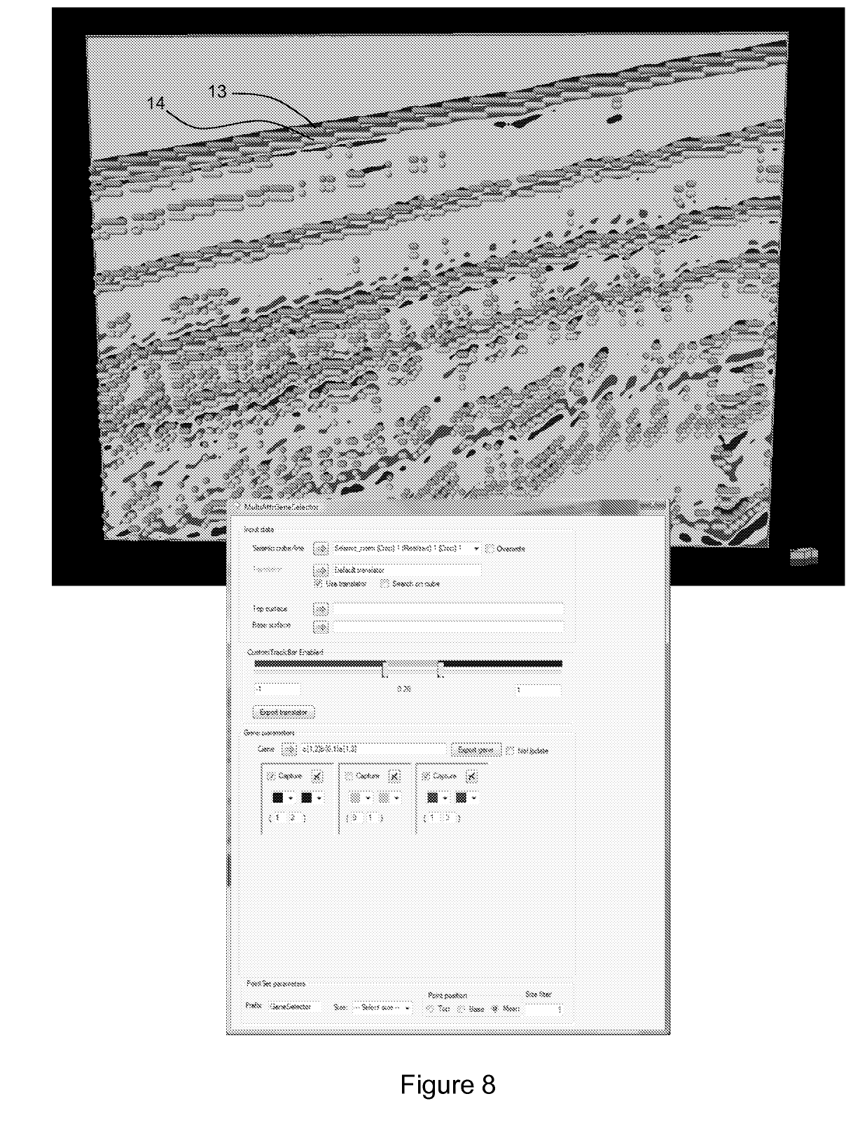

For example, FIG. 8 shows at top the translated seismic amplitude cross-section of FIG. 6. Overlayed on the cross-section are orange circles 13 showing data points matched to the first selected point and green circles 14 showing data points matched to the second selected point. There are matched points all over the cross-section, indicating that the search expression information is insufficient to properly distinguish between features of interest and other parts of the data. At bottom of FIG. 8 is the corresponding input data/translator/search expression GUI. The insufficient search expression is ([c]{1,2})[b]{0,1}([a]{1,3}). The matched points correspond to the first and third search expression entries.

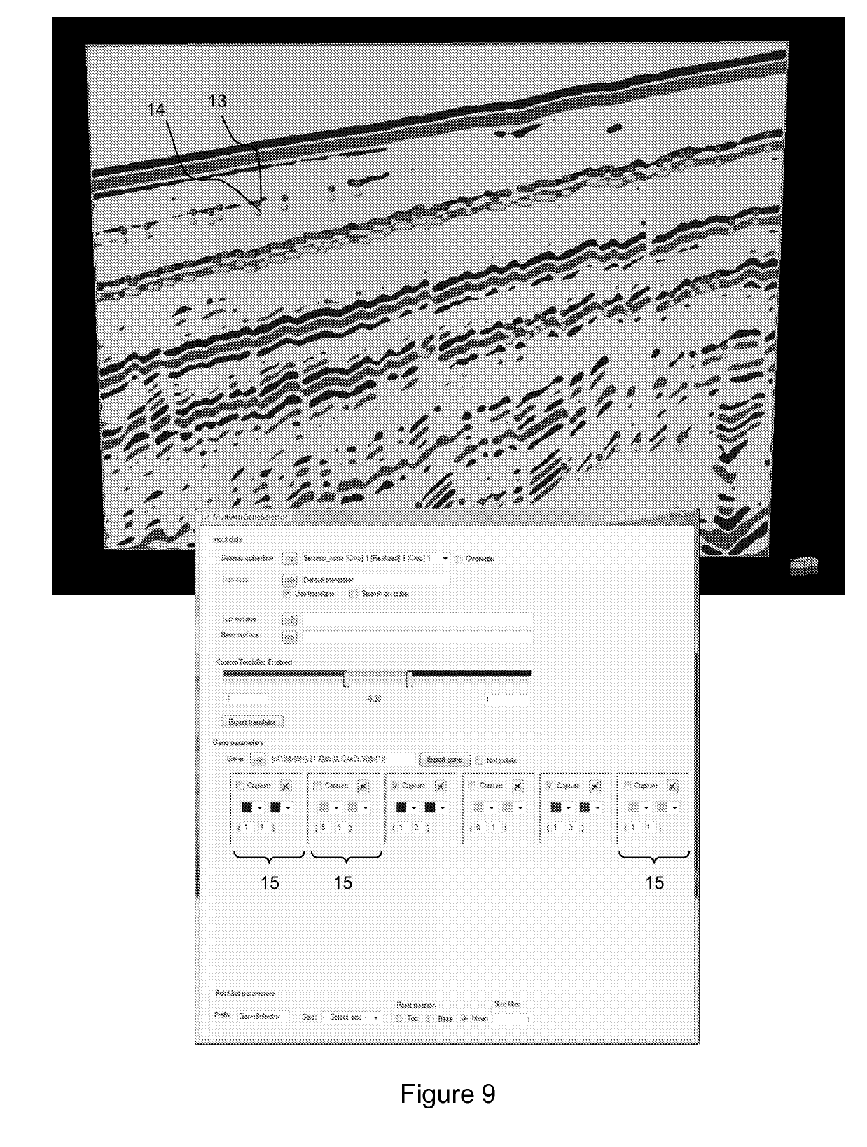

One approach to refine the search is to add entries to the search expression. FIG. 9 shows again at top the translated seismic amplitude cross-section of FIG. 6, and at bottom the corresponding GUI. However, in this case, the search expression has been increased by three further entries 15 to ([c]{1,1})[b]{5,5}([c]{1,2})[b]{0,1}([a]{1,3}[b]{1,1}). A better search result is achieved with significantly fewer matched points (now corresponding to the third and fifth search expression entries). However, a number of matches are still outside the features of interest.

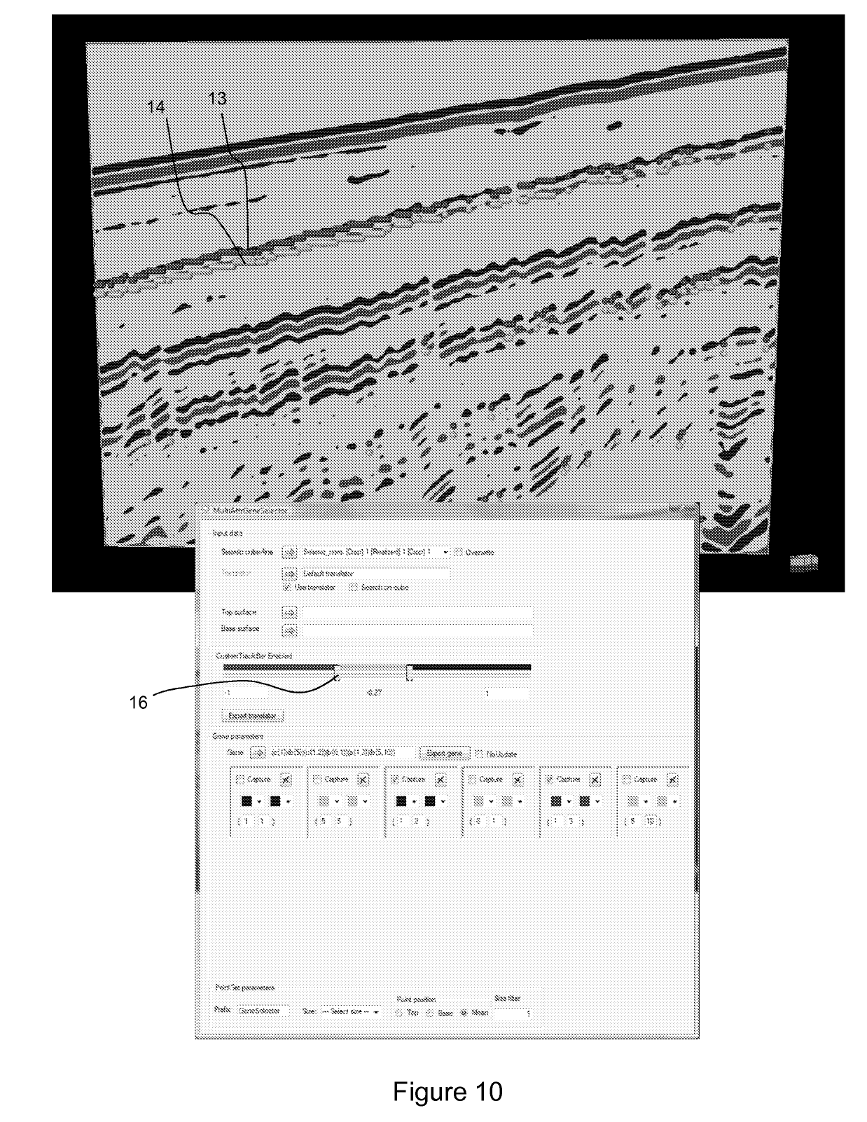

Thus another approach is to adjust the translator. FIG. 10 shows at top the translated seismic amplitude cross-section but, as shown at bottom in the corresponding GUI, the boundary 16 between the red and the green colour is moved to the left to increase the green value subrange [b] and decrease the red value subrange [a]. Now the matched points are almost exclusively restricted to features of interest.

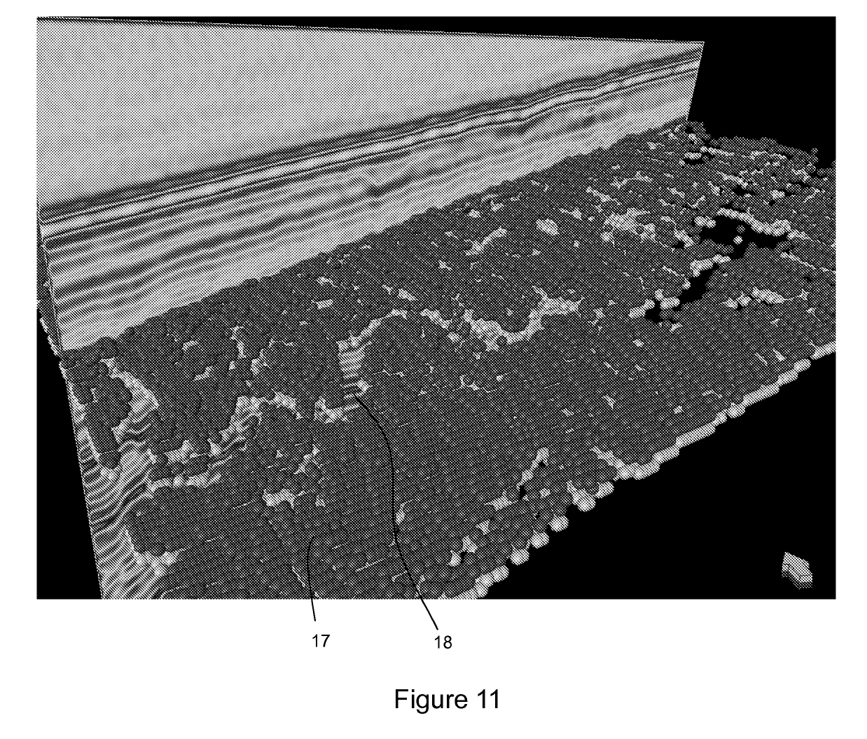

FIG. 11 shows the result of applying the translator and search expression across the 3D seismic volume from which the cross-section of FIGS. 6 and 8 to 10 was taken from. Circles again show matched data points. The search expression has extracted almost a complete surface 17, and the absent matches in that surface describe a geometric feature 18 which might be of significance.

The methodology described above can be extended to plural data sets, making it possible to create multi-attribute searches. In general, however, such data sets must be identical in extent.

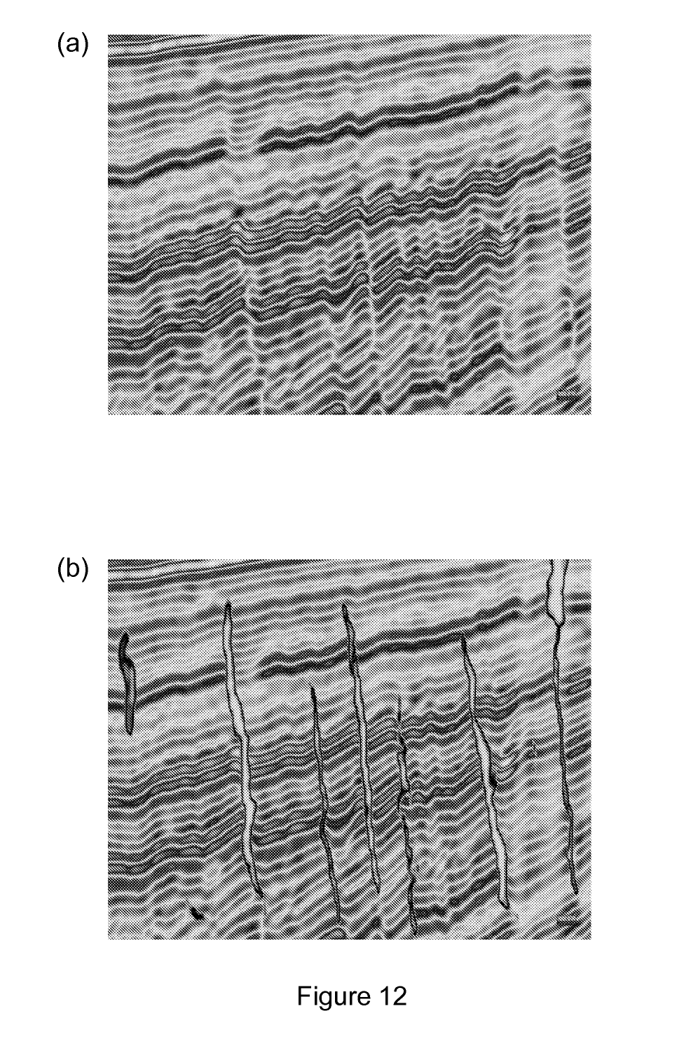

FIG. 12 shows (a) a seismic cross-section, and (b) the same seismic cross-section overlaid with AntTracks (described in U.S. Pat. No. 7,203,342) based on a chaos attribute (described in T. Randen and L. Sønneland, Atlas of 3D Seismic Attributes in Mathematical Methods and Modelling in Hydrocarbon Exploration and Production, A. Iske and T. Randen (eds.), Springer 2005, and T. Randen, E. Monsen, C. Signer, A. Abrahamsen, J. O. Hansen, T. Saether, J. Schlaf and L. Sønneland, Three-dimensional texture attribute for seismic data analysis, Expanded Abstr., Int. Mtg., Soc. Explorational Geophys., 2000). The AntTrack chaos attribute highlights seismic discontinuities such as faults.

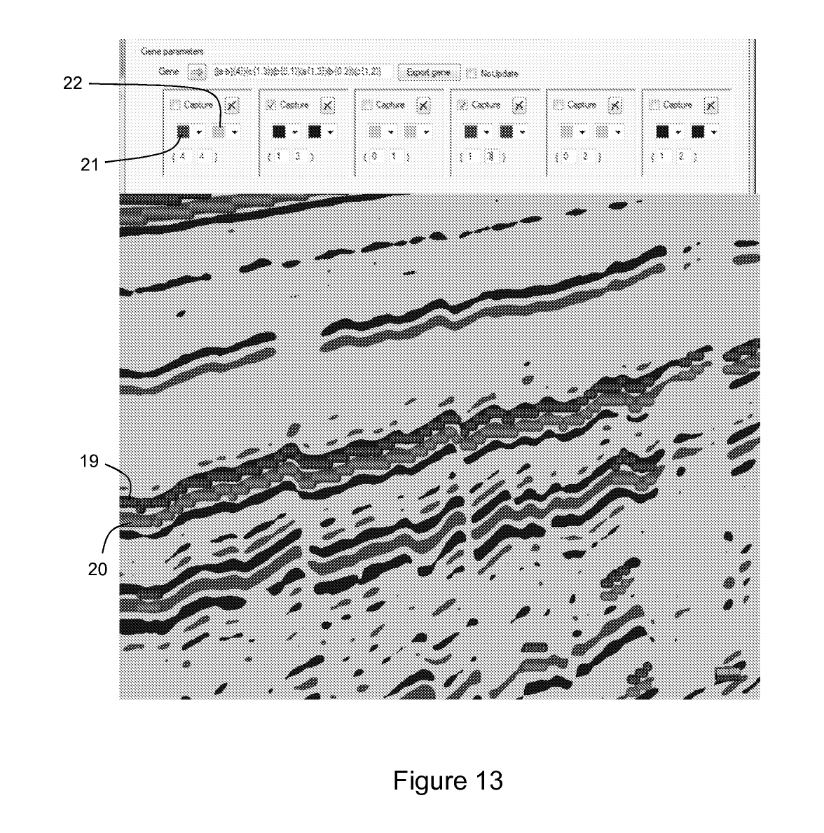

FIG. 13 shows at bottom the translated seismic cross-section of FIG. 12(a), with three value subranges represented by the colours red, green and blue. FIG. 13 also shows at top a six entry search expression that has produced the matched points indicated by circles 19, 20 in the cross-section. The matched points correspond to the second and fourth search expression entries. Note that the first entry of the search expression is ([a-b]{4,4}), where [a-b] indicates that the data points can be in the [a] or the [b] subrange (or any intermediate subrange, although in this case there are no subranges between [a] and [b]). The [a] is represented in the drop down box 21 by a red colour (for [a]), and the [b] is represented in the drop down box 22 by a green colour (for [b]).

The matched points 19, 20 follow two horizons, but it would be desirable to eliminate matches which superimpose on the faults or seismic discontinuities indicated by the AntTracks of FIG. 12(b).

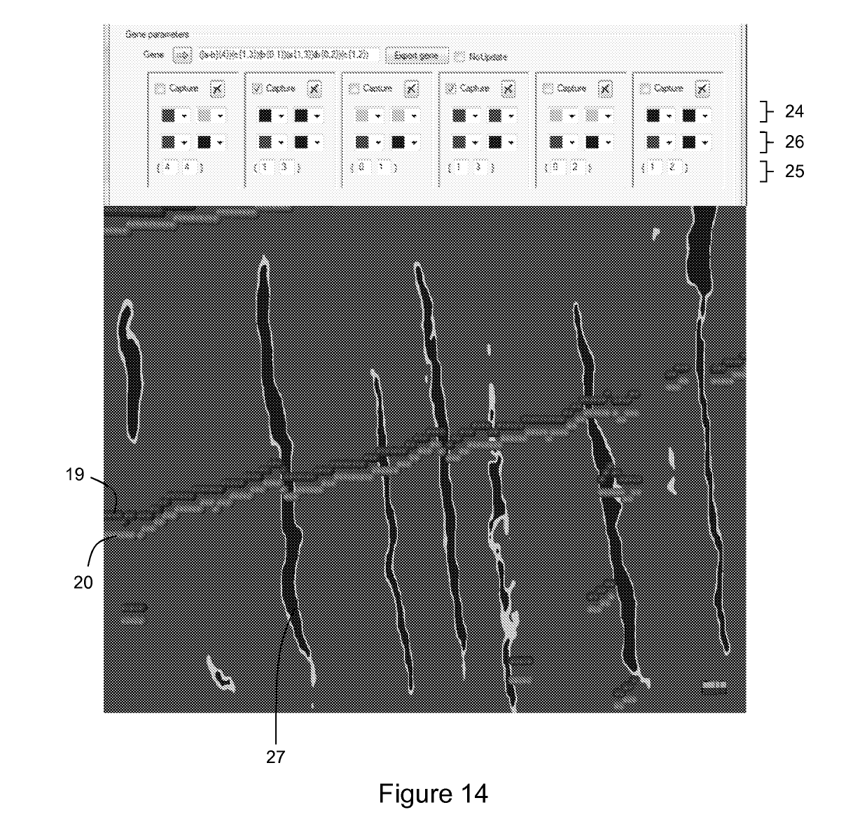

FIG. 14 shows at bottom the translated seismic cross-section of FIG. 12(b), with three (different) value subranges again represented by the colours red, green and blue. FIG. 14 also shows at top a row 24 of coloured drop down boxes, which represent the value subranges of the search expression shown in FIG. 13 and a row of text entry boxes 25 which provide the minimum and maximum vertical extents of each entry of the search expression shown in FIG. 13. However, in addition, FIG. 14 also shows at top a further row 26 of coloured drop down boxes, which, in combination with the row of text entry boxes 24, form a second search expression that reproduces the matched points 19, 20 in the cross-section of FIG. 14.

Thus, the first search expression relates to the first attribute of FIG. 12(a) and the second search expression relates to the second attribute of FIG. 12(b). In order to provide the same matched points in FIG. 14 as appear in FIG. 13, each of the six value subranges in the further row 26 spans the whole range (which in this case that is from red through green to blue, i.e. [a-c]).

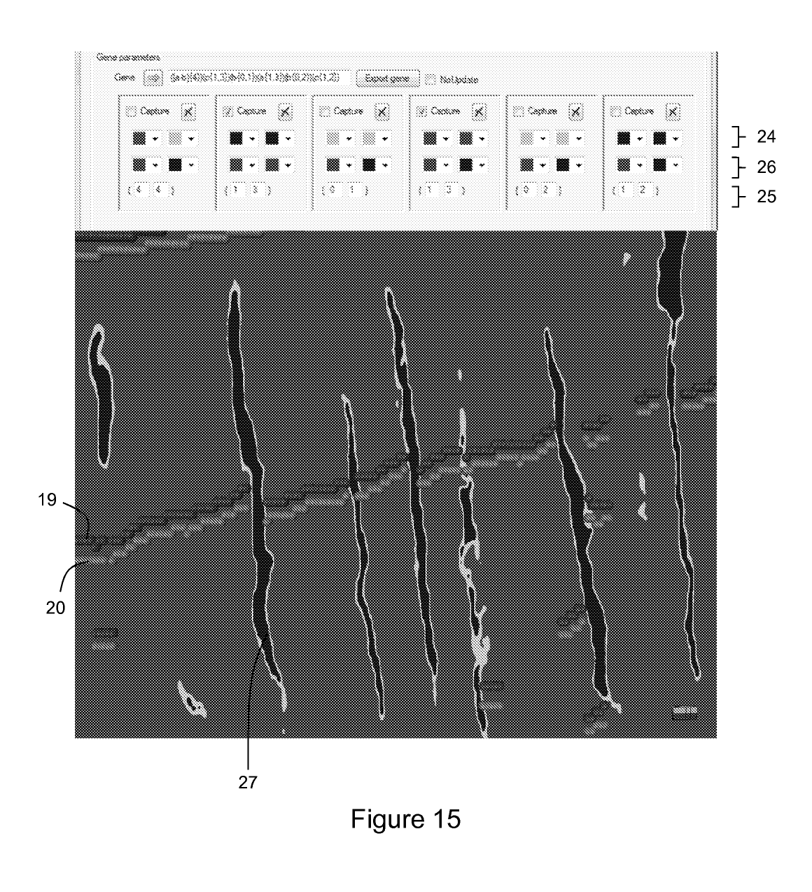

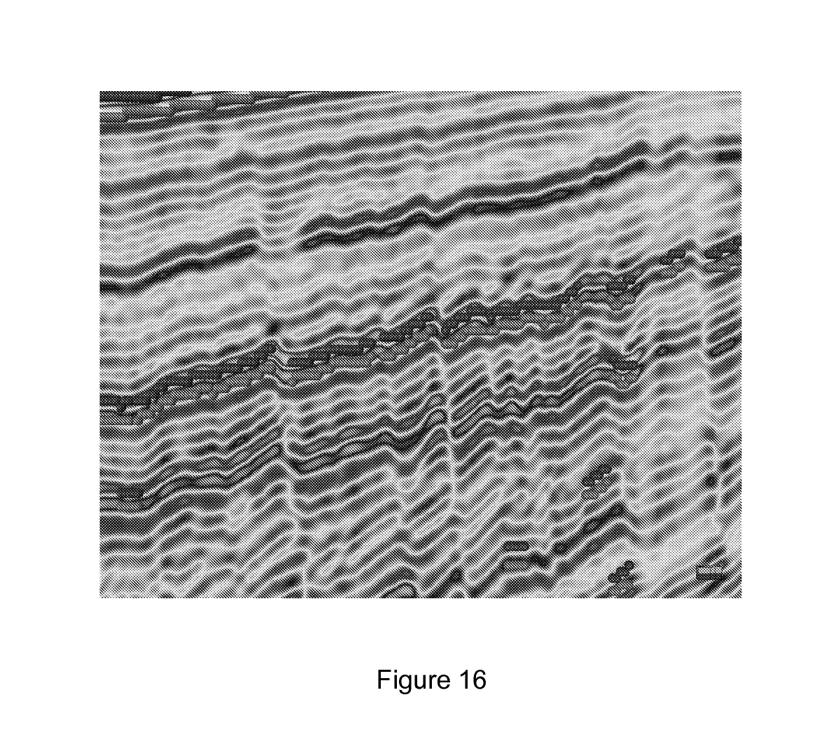

From FIG. 14, however, it is clear that the faults 27 are marked by blue and green colours. To eliminate the matches of the two horizons on the fault positions all that is needed is to change the colour range of one of the entries of the second search expression (i.e. row 26) to include only the red colour. FIG. 15 is identical to FIG. 14 except that this change has been made to the second entry of row 26, with the result that the matches at the fault positions have been removed. The new result is also shown in FIG. 16, but overlayed on the original seismic cross-section of FIG. 12(a).

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the scope of the invention.

All references referred to above are hereby incorporated by reference for all purposes.

1. A computer-implemented method of identifying a feature of interest in a set of data points distributed throughout a geological object, each data point containing a value for a geological attribute at that point, the method including the steps of:
providing a translator which defines a plurality of value subranges for the geological attribute;
displaying the geological object using display codings corresponding to the value subranges such that all data points which have values for the geological attribute falling within a given value subrange are displayed with the same coding;
repeatedly adjusting one or more end values of the value subranges, and redisplaying the geological object using the respective display codings for the adjusted value subranges, until the feature of interest is identifiable in the redisplayed geological object.

2. A method according to claim 1, further including the step of displaying the value subranges of the translator as translator GUI elements, and wherein the adjustment of the one or more end values of the value subranges is performed by adjusting the translator GUI elements.

3. A method according to claim 1, further including the step of determining a search expression describing the feature of interest, the search expression having a plurality of entries, wherein the determining step includes performing the steps of:
selecting a plurality of data points of the feature of interest; and
allocating value characters to entries of the search expression, the value characters corresponding to the value subranges for the geological attribute of the selected data points.

4. A computer-implemented method of determining a search expression describing a feature of interest in a set of data points distributed throughout a geological object, each data point containing a value for a geological attribute at that point, and the search expression having a plurality of entries, the method including the steps of:
displaying the geological object using display codings corresponding to value subranges for the geological attribute such that all data points which have values for the geological attribute falling within a given value subrange are displayed with the same coding;
selecting a plurality of data points of the feature of interest; and
allocating value characters to entries of the search expression, the value characters corresponding to the value subranges for the geological attribute of the selected data points.

5. A method according to claim 3, wherein the geological object is a 1D object, and the method further includes allocating extent characters to the entries of the search expression, each extent character being associated with a respective entry and specifying the vertical extent of the continuous line of data points which share the value subrange of that entry and which include the selected data point of that entry.

6. A method according to claim 3, wherein the geological object is a 2D object, and the method further includes allocating pairs of extent characters to the entries of the search expression, each pair of extent characters being associated with a respective entry and specifying the minimum and maximum vertical extents of the contiguous area of data points which share the value subrange of that entry and which include the selected data point of that entry.

7. A method according to claim 3, wherein the geological object is a 3D object, and the method further includes allocating pairs of extent characters to the entries of the search expression, each pair of extent characters being associated with a respective entry and specifying the minimum and maximum vertical extents of the contiguous volume of data points which share the value subrange of that entry and which include the selected data point of that entry.

8. A method according to claim 3, further including the step of displaying the value characters of the search expression as search expression GUI elements using said display codings.

9. A method according to claim 3, further including modifying one or more value characters of the search expression.

10. A method according to claim 3, further including the steps of:
searching the set of data points for arrangements of data points having geological attributes matching the search expression;
identifying matched arrangements of data points; and
redisplaying the geological object and indicating the positions of the matched arrangements of data points.

11. A method according to claim 10, wherein each data point also contains a value for a second geological attribute at that point, the method further including the steps of:
displaying the geological object using second display codings corresponding to second value subranges for the second geological attribute such that all data points which have values for the second geological attribute falling within a given second value subrange are displayed with the same second coding, and indicating the positions of the matched arrangements of data points; and
determining a second search expression having entries corresponding to the entries of the first search expression but having value characters which correspond to the second value subranges for the second geological attribute of the matched arrangements of data points.

12. A method according to claim 11, further including the step of displaying the value characters of the second search expression as second search expression GUI elements using said second display codings.

13. A method according to claim 11, further including the steps of:
modifying one or more value characters of the second search expression; and
redisplaying the geological object and indicating the positions of the previously matched arrangements of data points which still match the modified second search expression.

14. A method according to claim 10 wherein each data point also contains a value for one or more additional geological attributes at that point, and the or each additional geological attribute has corresponding value subranges, the method further including the step of:
determining one or more additional search expressions, the or each additional search expression having entries corresponding to the entries of the first search expression but having value characters which correspond to the value subranges for a respective one of the additional geological attributes according to the matched arrangements of data points.

15. A method of processing seismic data including the steps of:
performing seismic tests to obtain seismic data for a geological volume;
performing the method of claim 1, the set of data points being based on the seismic data or a subset of the seismic data.

16. A method of controlling a well drilling operation including the steps of:
performing the method of any one of claims 10 to 14, or of claim 15 as dependent on claim 1, to identify features of interest corresponding to the matched arrangements of data points;
determining a well trajectory which extends through the geological object taking account of the identified features of interest; and
drilling a well having the specified trajectory.

17. A computer system for performing the method of claim 1.

18. A computer program product carrying a program for performing the method of claim 1.

19. A computer program for performing the method of claim 1.
